(19) United States
(12) Patent Application Publication
(10) Pub. No.: US 2023/0396802 A1
(43) Pub. Date: Dec. 7, 2023

(54) SYSTEM AND METHOD OF STREAMING COMPRESSED MULTIVIEW VIDEO

(71) Applicant: LEIA INC., Menlo Park, CA (US)

(72) Inventor: Nicolas Dahlquist, Redwood City, CA (US)

(21) Appl. No.: 18/234,820

(22) Filed: Aug. 16, 2023

Related U.S. Application Data
(63) Continuation of application No. PCT/US2021/020164, filed on Feb. 28, 2021.

(51) Int. Cl. H04N 19/597; H04N 13/351; G06V 10/141

(52) U.S. Cl. CPC H04N 19/597; H04N 13/351; G06V 10/141

(57) ABSTRACT

Systems and methods are directed to streaming multiview video from a sender system to a receiver system. A sender system may capture an interlaced frame of a multiview video rendered on a multiview display of the sender client device. The interlaced frame may be formatted as spatially multiplexed views defined by a multiview configuration having a first number of views. The sender system may deinterlace the spatially multiplexed views of the interlaced frame into separate views. The sender system may concatenate the separated views to generate a tiled frame of a tiled video. The sender system may transmit the tiled video to a receiver client device, where the tiled video is compressed. The receiver system may decompress and interlace the views of the tiled video into streamed interlaced frames and render the streamed interlaced frames on a multiview display of the receiver system.

### CROSS-REFERENCE TO RELATED APPLICATIONS

This application is a continuation patent application of and claims priority to International Patent Application No. PCT/US2021/020164, filed Feb. 28, 2021, the entirety of which is incorporated by reference herein.

### STATEMENT REGARDING FEDERALLY SPONSORED RESEARCH OR DEVELOPMENT

N/A

### BACKGROUND

A two-dimensional (2D) video stream includes a series of frames, where each frame is a 2D image. Video streams may be compressed according to a video coding specification to reduce the video file size, thereby alleviating network bandwidth. A video stream may be received by a computing device from a variety of sources. Video streams may be decoded and rendered for display by a graphics pipeline. The rendering of these frames at a particular frame rate produces a display of video to be viewed by a user.

Multiview displays are an emerging display technology that provide a more immersive viewing experience comparted conventional 2D video. There may be challenges to rendering, processing, and compressing multiview video compared to handling 2D video.

### BRIEF DESCRIPTION OF THE DRAWINGS

Various features of examples and embodiments in accordance with the principles described herein may be more readily understood with reference to the following detailed description taken in conjunction with the accompanying drawings, where like reference numerals designate like structural elements.

FIG. 1 illustrates a multiview image in an example, according to an embodiment consistent with the principles described herein.

FIG. 2 illustrates an example of a multiview display, according to an embodiment consistent with the principles described herein.

FIG. 3 illustrates an example of streaming multiview video by a sender client device, according to an embodiment consistent with the principles described herein.

FIG. 4 illustrates an example of receiving streamed multiview video from a sender client device according to an embodiment consistent with the principles described herein.

FIG. 5 illustrates an example of the functionality and architectures of sender and receiver systems, according to an embodiment consistent with the principles described herein.

FIG. 6 is a schematic block diagram that depicts an example illustration of a client device according to an embodiment consistent with the principles described herein.

Certain examples and embodiments have other features that are one of in addition to and in lieu of the features illustrated in the above-referenced figures. These and other features are detailed below with reference to the above-referenced figures.

### DETAILED DESCRIPTION

Examples and embodiments in accordance with the principles described herein provide techniques to stream multiview video between client devices (e.g., from a sender to one or more receivers). For example, multiview video that is display on one client device can be processed, compressed, and streamed to one or more target devices. This allows the lightfield experience (e.g., the presentation of multiview content) to be replicated in real time across different devices. One consideration for designing a video streaming system is the ability to compress the video stream. Compression refers to a process that reduces the size (in terms of bits) of the video data while maintaining a minimum amount of video quality. Without compression, the time it takes to completely stream video increases or otherwise strains network bandwidth. Video compression may, therefore, allow for reduced video stream data to support real-time video streaming, faster video streaming, or reduced buffering of an incoming video stream. Compression may be a lossy compression, meaning that the compression and decompression of the input data causes some loss in quality.

Embodiments are directed to streaming multiview video in a manner that is agnostic to the multiview configuration of the target devices. In addition, any application that plays multiview content may accommodate real-time streaming of the multiview content to target devices without changing the underlying code of the application.

Operations may involve rendering interlaced multiview video where the different views of the multiview video are interlaced to natively support a multiview display. In this respect, the interlaced video is uncompressed. Interlacing the different views may provide the multiview content in a suitable format for rendering on a device. A multiview display is hardware that may be configured according to a particular multiview configuration for displaying interlaced multiview content.

Embodiments are further directed to the ability to stream (e.g., in real time) multiview content from a sender client device to a receiver client device. Multiview content that is rendered on the sender client device may be captured and deinterlaced to consolidate each view. Thereafter, each view may be concatenated to generate a tiled frame of concatenated views (e.g., a deinterlaced frame). A video stream having tiled frames is then compressed and transmitted to a receiver client device. The receiver client device may decompress, deinterlace, and render the resulting video. This allows the receiver client device to present lightfield content that is similar to the lightfield content rendered on the sender client device for real-time playback and streaming.

According to some embodiments, the sender client device and the receiver client device may have different multiview configurations. A multiview configuration refers to the number of views presented by the multiview display. For example, a multiview display that presents only a left and right view has a stereo multiview configuration. A four-view multiview configuration means that the multiview display can display four views, etc. In addition, the multiview configuration may also refer to the orientation of the views. Views may be orientated horizontally, vertically, or both. For example, a four-view multiview configuration may be oriented horizontally with four views across, may be oriented vertically with four views down, or may be oriented in a quad orientation with two views across and two views down. The receiver client device may modify the number of views of the received tiled video to make it compatible with the multiview configuration of the multiview display of the receiver client device. In this respect, a tiled video stream is agnostic to the multiview configuration of the receiver client device.

Embodiments discussed herein support multiple use cases. For example, a sender client device may live stream multiview content to one or more receiver client devices. The sender client device may therefore provide a screen-share functionality for sharing lightfield video with other client devices that can replicate the lightfield experience rendered at the sender client device. In addition, a set of receiver client devices may be heterogeneous such that they each have different multiview configurations. For example, a set of receiver client devices that receive the same multiview video stream may render the multiview video in their own multiview configurations. For example, a receiver client device may render the received multiview video stream as four views while another receiver client device may render the same received multiview video stream as eight views.

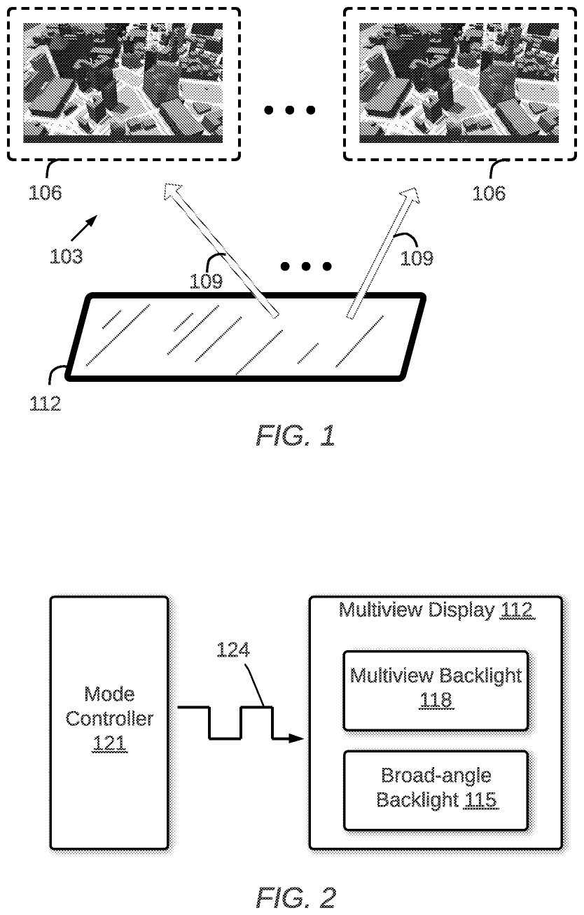

FIG. 1 illustrates a multiview image in an example, according to an embodiment consistent with the principles described herein. A multiview image 103 may be a single, multiview video frame from a multiview video stream at a particular timestamp. The multiview image 103 may also be a static multiview image that is not part of a video feed. The multiview image 103 has a plurality of views 106 (e.g., view images). Each of the views 106 corresponds to a different principle angular direction 109 (e.g., a left view, a right view, etc.). The views 106 are rendered on a multiview display 112. Each view 106 represents a different viewing angle of a scene represented by the multiview image 103. The different views 106 therefore have some level of disparity with respect to one another. A viewer may perceive one view 106 with her right eye while perceiving a different view 106 with her left eye. This allows a viewer to perceive different views 106 contemporaneously, thereby experiencing a three-dimensional (3D) effect.

In some embodiments, as a viewer physically changes her viewing angle with respect to the multiview display 112, the eyes of the viewer may catch different views 106 of the multiview image 103. As a result, the viewer may interact with the multiview display 112 to see different views 106 of the multiview image 103. For example, as the viewer moves to the left, the viewer may see more of the left side of the scene in the multiview image 103. The multiview image 103 may have multiple views 106 along a horizontal plane and/or have multiple views 106 along the vertical plane. Thus, as a user changes the viewing angle to see different views 106, the viewer may gain additional visual details of the scene in the multiview image 103.

As discussed above, each view 106 is presented by the multiview display 112 at different, corresponding principal angular directions 109. When presenting the multiview image 103 for display, the views 106 may actually appear on or in a vicinity of the multiview display 112. A characteristic of observing lightfield video is the ability to contemporaneously observe different views. Lightfield video contains visual imagery that may appear in front of the screen as well as behind the screen so as to convey a sense of depth to the viewer.

A 2D display may be substantially similar to the multiview display 112, except that the 2D display is generally configured to provide a single view (e.g., only one of the views) as opposed to the different views 106 of the multiview image 103. Herein a ‘two-dimensional display’ or ‘2D display’ is defined as a display configured to provide a view of an image that is substantially the same regardless of a direction from which the image is viewed (i.e., within a predefined viewing angle or range of the 2D display). A conventional liquid crystal display (LCD) found in many smart phones and computer monitors are examples of 2D displays. In contrast herein, a ‘multiview display’ is defined as an electronic display or display system configured to provide different views of a multiview image (e.g., multiview frame) in or from different view directions contemporaneously from the perspective of the user. In particular, the different views 106 may represent different perspective views of a multiview image 103.

The multiview display 112 may be implemented using a variety of technologies that accommodate the presentation of different image views so that they are perceived contemporaneously. One example of a multiview display is one that employs multibeam elements that scatter light to control the principle angular directions of the different views 106. According to some embodiments, the multiview display 112 may be a lightfield display, which is one that presents a plurality of light beams of different colors and different directions corresponding to different views. In some examples, the lightfield display is a so-called ‘glasses free’ three-dimensional (3-D) display that may use multibeam elements (e.g., diffractive gratings) to provide autostereoscopic representations of multiview images without the need to wear special eyewear to perceive depth.

FIG. 2 illustrates an example of a multiview display, according to an embodiment consistent with the principles described herein. A multiview display 112 may generate lightfield video when operating in a multiview mode. In some embodiments, the multiview display 112 renders multiview images as well as 2D images depending on its mode of operation. For example, the multiview display 112 may include a plurality of backlights to operate in different modes. The multiview display 112 may be configured to provide broad-angle emitted light during a 2D mode using a broad-angle backlight 115. In addition, the multiview display 112 may be configured to provide directional emitted light during a multiview mode using a multiview backlight 118 having an array of multibeam elements, the directional emitted light comprising a plurality of directional light beams provided by each multibeam element of the multibeam element array. In some embodiments, the multiview display 112 may be configured to time multiplex the 2D and multiview modes using a mode controller 121 to sequentially activate the broad-angle backlight 115 during a first sequential time interval corresponding to the 2D mode and the multiview backlight 118 during a second sequential time interval corresponding to the multiview mode. Directions of directional light beams of the directional light beam may correspond to different view directions of a multiview image 103. The mode controller 121 may generate a mode selection signal 124 to activate the broad-angle backlight 115 or multiview backlight 118.

In 2D mode, the broad-angle backlight 115 may be used to generate images so that the multiview display 112 operates like a 2D display. By definition, ‘broad-angle’ emitted light is defined as light having a cone angle that is greater than a cone angle of the view of a multiview image or multiview display. In particular, in some embodiments, the broad-angle emitted light may have a cone angle that is greater than about twenty degrees (e.g., >±20°). In other embodiments, the broad-angle emitted light cone angle may be greater than about thirty degrees (e.g., >±30°), or greater than about forty degrees (e.g., >±40°), or greater than about fifty degrees (e.g., >±50°). For example, the cone angle of the broad-angle emitted light may be greater than about sixty degrees (e.g., >±60°).

The multiview mode may use a multiview backlight 118 instead of a broad-angle backlight 115. The multiview backlight 118 may have an array of multibeam elements on a top or bottom surface that scatter light as plurality of directional light beams having principal angular directions that differ from one another. For example, if the multiview display 112 operates in a multiview mode to display a multiview image having four views, the multiview backlight 118 may scatter light into four directional light beams, each directional light beam corresponding to a different view. A mode controller 121 may sequentially switch between 2D mode and multiview mode so that a multiview image is displayed in a first sequential time interval using the multiview backlight and a 2D image is displayed in a second sequential time interval using the broad-angle backlight. The directional light beams may be at predetermined angles, where each directional light beam corresponds to a different view of the multiview image.

In some embodiments, each backlight of the multiview display 112 is configured to guide light in a light guide as guided light. Herein, a ‘light guide’ is defined as a structure that guides light within the structure using total internal reflection or ‘TIR’. In particular, the light guide may include a core that is substantially transparent at an operational wavelength of the light guide. In various examples, the term ‘light guide’ generally refers to a dielectric optical waveguide that employs total internal reflection to guide light at an interface between a dielectric material of the light guide and a material or medium that surrounds that light guide. By definition, a condition for total internal reflection is that a refractive index of the light guide is greater than a refractive index of a surrounding medium adjacent to a surface of the light guide material. In some embodiments, the light guide may include a coating in addition to or instead of the aforementioned refractive index difference to further facilitate the total internal reflection. The coating may be a reflective coating, for example. The light guide may be any of several light guides including, but not limited to, one or both of a plate or slab guide and a strip guide. The light guide may be shaped like a plate or slab. The light guide may be edge lit by a light source (e.g., light emitting device).

In some embodiments, the multiview backlight 118 of the multiview display 112 is configured to scatter out a portion of the guided light as the directional emitted light using multibeam elements of the multibeam element array, each multibeam element of the multibeam element array comprising one or more of a diffraction grating, a micro-refractive element, and a micro-reflective element. In some embodiments, a diffraction grating of a multibeam element may comprise a plurality of individual sub-gratings. In some embodiments, a micro-reflective element is configured to reflectively couple or scatter out the guided light portion as the plurality of directional light beams. The micro-reflective element may have a reflective coating to control the way guided light is scattered. In some embodiments, the multibeam element comprises a micro-refractive element that is configured to couple or scatter out the guided light portion as the plurality of directional light beams by or using refraction (i.e., refractively scatter out the guided light portion).

The multiview display 112 may also include a light valve array positioned above the backlights (e.g., above the broad-angle backlight 115 and above the multiview backlight 118). The light valves of the light valve array may be, for example, liquid crystal light valves, electrophoretic light valves, light valves based on or employing electrowetting, or any combination thereof. When operating in 2D mode, the broad-angle backlight 115 emits light towards the light valve array. This light may be diffuse light emitted at a broad angle. Each light valve is controlled to achieve a particular pixel valve to display a 2D image as it is illuminated by light emitted by the broad-angle backlight 115. In this respect, each light valve corresponds to a single pixel. A single pixel, in this respect, may include different color pixels (e.g., red, green blue) that make up a single pixel cell (e.g., LCD cell).

When operating in multiview mode, the multiview backlight 118 emits directional light beams to illuminate the light valve array. Light valves may be grouped together to form a multiview pixel. For example, in a four-view multiview configuration, a multiview pixel may comprise for different pixels, each corresponding to a different view. Each pixel in a multiview pixel may further comprise different color pixels.

Each light valve in a multiview pixel arrangement may be illuminated by its one of the light beams having a principle angular direction. Thus, a multiview pixel is a pixel grouping that provides different views of a pixel of a multiview image. In some embodiments, each multibeam element of the multiview backlight 118 is dedicated to a multiview pixel of the light valve array.

The multiview display 112 comprises a screen to display a multiview image 103. The screen may be a display screen of a telephone (e.g., mobile telephone, smart phone, etc.), a tablet computer, a laptop computer, a computer monitor of a desktop computer, a camera display, or an electronic display of substantially any other device, for example.

As used herein, the article ‘a’ is intended to have its ordinary meaning in the patent arts, namely ‘one or more’. For example, ‘a processor’ means one or more processor and as such, ‘the memory’ means ‘one or more memory components’ herein.

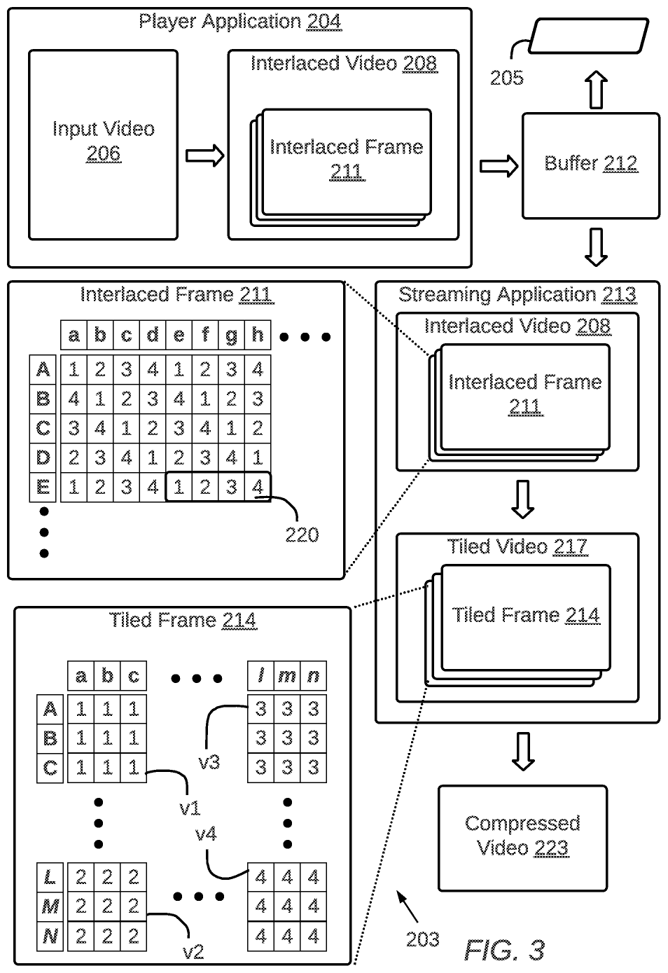

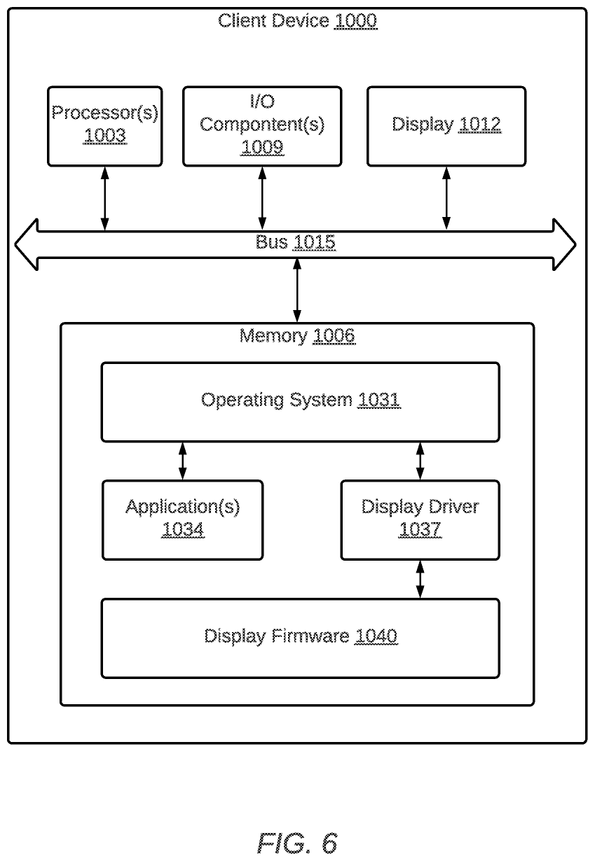

FIG. 3 illustrates an example of streaming multiview video by a sender client device, according to an embodiment consistent with the principles described herein. A sender client device 203 is a client device that is responsible for transmitting video content to one or more receivers. An example of a client device is discussed in further detail with respect to FIG. 6. The sender client device 203 may execute a player application 204 that is responsible for rendering multiview content on a multiview display 205 of the sender client device 203. A player application 204 may be a user-level application that receives or otherwise generates input video 206 and renders it on the multiview display 205. The input video 206 may be multiview video that is formatted in any multiview video format such that each frame of the input video 206 comprises multiple views of a scene. For example, each rendered frame of the input video 206 may be similar to the multiview image 103 of FIG. 1. The player application 204 may convert the input video 206 in interlaced video 208, where interlaced video 208 is made up of interlaced frames 211. Interlaced video 208 is discussed in further detail below. As part of the rendering process, the player application 204 may load the interlaced video 208 into a buffer 212. The buffer 212 may be a primary framebuffer that stores image content that is then displayed on the multiview display 205. The buffer 212 may be part of the graphics memory that is used to render images on the multiview display 112.

Embodiments of the present disclosure are directed to a streaming application 213 that may operate in parallel with the player application 204. The streaming application 213 may execute in the sender client device 203 as a background service or routine that is invoked by the player application 204 or by other user input. The streaming application 213 is configured to share the multiview content that is rendered on the sender client device 203 with one or more receiver client devices.

For example, the functionality of the sender client device 203 (e.g., the streaming application 213 of the sender client device 203) includes capturing an interlaced frame 211 of an interlaced video 208 rendered on a multiview display 205 of the sender client device 203, the interlaced frame 211 being formatted as spatially multiplexed views defined by a multiview configuration having a first number of views (e.g., four views shown as view 1 through view 4). The sender client device 203 may also execute operations that include deinterlacing the spatially multiplexed views of the interlaced frame into separate views, the separate views being concatenated to generate a tiled frame 214 of a tiled video 217. The sender client device 203 may also execute operations that include transmitting the tiled video 217 to a receiver client device, the tiled video being compressed as compressed video 223.

The multiview display 205 may be similar to the multiview display 112 of FIG. 1 or FIG. 2. For example, the multiview display 205 may be configured to time-multiplex between a 2D mode and 3D mode by switching between a broad-angle backlight and a multiview backlight. The multiview display 205 may present lightfield content (e.g., lightfield video or lightfield static images) to a user of the sender client device 203. For example, lightfield content refers to, for example, multiview content (e.g., interlaced video 208 which comprises interlaced frames 211). As mentioned above, a player application 204 and graphics pipeline may process and render the interlaced video 208 on the multiview display 205. Rendering involves generating pixel values of an image that are then mapped to the physical pixels of the multiview display 205. A multiview backlight 118 may be selected and light valves of the multiview display 205 may be controlled to produce multiview content for the user.

A graphics pipeline is a system that renders image data for display. A graphics pipeline may include one or more graphics processing units (GPUs), GPU cores, or other specialized processing circuits that are optimized for rendering image content to a screen. For example, GPUs may include vector processors that execute an instruction set to operate on an array of data in parallel. The graphics pipeline may include a graphics card, graphics drivers, or other hardware and software used to render graphics. The graphics pipeline may map pixels from graphics memory onto corresponding locations of a display and control the display to emit light to render the image. The graphics pipeline may be a subsystem that is separate from a central processing unit (CPU) of the sender client device 203. For example, the graphics pipeline may include specialized processors (e.g., GPUs) that are separate from the CPU. In some embodiments, the graphics pipeline is implemented purely as software by the CPU. For example, the CPU may execute software modules that operate as a graphics pipeline without specialized graphics hardware. In some embodiments, portions of the graphics pipeline are implemented in specialized hardware while other portions are implemented as software modules by the CPU.

As mentioned above, operations performed by the streaming application 213 include capturing an interlaced frame 211 of an interlaced video 208. To elaborate further, the image data processed in the graphics pipeline may be accessed using functional calls or application programming interface (API) calls. This image data may be referred to as a texture which includes pixel arrays comprising pixel values at different pixel coordinates. For example, texture data may include the values of a pixel such as, for example, the values of each color channel or transparency channel, gamma values, or other values that characterize the color, brightness, intensity, or transparency of a pixel. An instruction may be sent to the graphics pipeline to capture each interlaced frame 211 of the interlaced video 208 rendered on a multiview display 205 of the sender client device 203. Interlaced frames 211 may be stored in graphics memory (e.g., texture memory, memory accessible to a graphic processor, memory that stores an output that is rendered). Interlaced frames 211 may be captured by copying or otherwise accessing texture data that represents rendered frames (e.g., frames that are rendered or about to be rendered). Interlaced frames 211 may be formatted in a format that is native to the multiview display 205. This allows the firmware or device drivers of the multiview display 205 to control light valves of the multiview display 205 to present the interlaced video 208 to the user as a multiview image (e.g., multiview image 103). Capturing an interlaced frame 211 of the interlaced video 208 may comprise accessing texture data from graphics memory using an application programming interface (API).

The interlaced frame 211 is in an uncompressed format. The interlaced frame 211 may be formatted as spatially multiplexed views defined by a multiview configuration having a first number of views (e.g., 2 views, 4 views, 8 views, etc.). In some embodiments, the multiview display 205 may be configured according to a particular multiview configuration. A multiview configuration is a configuration that defines the maximum number of views that the multiview display 205 can present at a time as well as the orientation of those views. The multiview configuration may be a hardware limitation of the multiview display 205 that defines how it presents multiview content. Different multiview displays may have different multiview configurations (e.g., in terms of the number of views it can present or the orientation of the views).

As shown in FIG. 3, each interlaced frame 211 has views that are spatially multiplexed. FIG. 3 shows pixels that correspond to one of four views, where the pixels are interlaced (e.g., interleaved or spatially multiplexed). Pixels belonging to View 1 are represented by the number 1, pixels belonging to View 2 are represented by the number 2, pixels belonging to View 3 are represented by the number 3, and pixels belonging to View 4 are represented by the number 4. The views are interlaced on a pixel-basis, horizontally along each row. The interlaced frame 211 has rows of pixels represented by uppercase letters A-E and columns of pixels represents by lowercase letters a-h. FIG. 3 shows the location of one multiview pixel 220 at row E, columns e-h. The multiview pixel 220 is an arrangement of pixels from pixels of each of the four views. In other words, the multiview pixel 220 is a result of spatially multiplexing the individual pixels of each of the four views so that they are interlaced. While FIG. 3 shows spatially multiplexing the pixels of the different views in the horizontal direction, the pixels of the different views may be spatially multiplexed in the vertical direction as well as in both the horizontal and vertical directions.

The spatially multiplexed views may result in a multiview pixel 220 having pixels from each of the four views. In some embodiments, multiview pixels may be staggered in a particular direction, as shown in FIG. 3, where the multiview pixels are aligned horizontally while being staggered vertically. In other embodiments, the multiview pixels may be staggered horizontally and aligned vertically. The particular way multiview pixels are spatially multiplexed and staggered may depend on the design of the multiview display 205 and its multiview configuration. For example, the interlaced frame 211 may interlace pixels and arrange its pixels into multiview pixels to allow them to be mapped to the physical pixels (e.g., light valves) of the multiview display 205. In other words, the pixel coordinates of the interlaced frame 211 correspond to physical locations of the multiview display 205.

Next, the streaming application 213 of the sender client device 203 may deinterlace the spatially multiplexed views of the interlaced frame 211 into separate views. Deinterlacing may involve separating each pixel of a multiview pixel to form separated views. The views are therefore consolidated. While the interlaced frame 211 mixes the pixels so that they are unseparated, deinterlacing separates pixels into separate views. This process may generate a tiled frame 214 (e.g., a deinterlaced frame). Moreover, each separate view may be concatenated so that they are placed adjacent to one another. Thus, the frame is tiled such that each tile in the frame represents a different, deinterlaced, view. Views may be positioned or otherwise tiled in a side-by-side arrangement in the horizontal direction, in the vertical direction, or both. The tiled frame 214 may have about the same number of pixels as the interlaced frame 211, however, the pixels in the tiled frame are arranged into separate views (shown as v1, v2, v3, and v4). The pixel array of the tiled frame 214 is shown to span rows A-N and span columns a-n. Pixels belonging to view 1 are positioned in the upper left quadrant, pixels belonging to view 2 are positioned in the lower left quadrant, pixels belonging to view 3 are positioned in the upper right quadrant, and pixels belonging to view 4 are positioned in the lower right quadrant. In this example, each tiled frame 214 would appear to a viewer as four separate views arranged in a quadrant. The tiled format of a tiled frame 214 is intended for transmission or streaming purposes and may not actually be used for presentation to a user. This tiled frame format is better suited for compression. In addition, the tiled frame format allows for receiver client devices with varying multiview configurations to render multiview video streamed from a sender client device 203. Together, the tiled frames 214 form a tiled video 217.

The sender client device 203 may then transmit the tiled video 217 to a receiver client device, the tiled video being compressed as compressed video 223. The compressed video 223 may be generated using a video encoder (e.g., compressor) (e.g., Coder Decoder (CODEC)) that conforms to a compression specification such as, for example, H.264 or any other CODEC specification. Compression may involve the generation of converting a series of frames into I-frames, P-frames, and B-frames as defined by the CODEC. As indicated above, each frame that is ready for compression is a frame that includes deinterlaced, concatenated views of a multiview image. In some embodiments, transmitting the tiled video 217 comprises streaming the tiled video 217 in real time using an API. Real-time streaming allow the content that is presently being rendered to also be streamed to remote devices so that the remote devices can also view the content in real time. A third-party service may provide APIs for compressing and streaming tiled video 217. In some embodiments, the sender client device 203 may perform operations that include compressing the tiled video 217 prior to transmitting the tiled video 217. The sender client device 203 may include a hardware or software video encoder for compressing video. The compressed video 223 may be streamed using a cloud service (e.g., over the internet) via a server. The compressed video 223 may also be streamed via a peer-to-peer connection between the sender client device 203 and one or more receiver client devices.

The streaming application 213 allows for any number of player applications 204 to share rendered content with one or more receiver client devices. In this respect, rather than having to modify each player application 204 of the sender client device 203 to support real-time streaming, the streaming application 213 captures multiview content and streams it to receiver client devices in a format that is suitable for compression. In this respect, any player application 204 can support real-time multiview video streaming by working in conjunction with the streaming application 213.

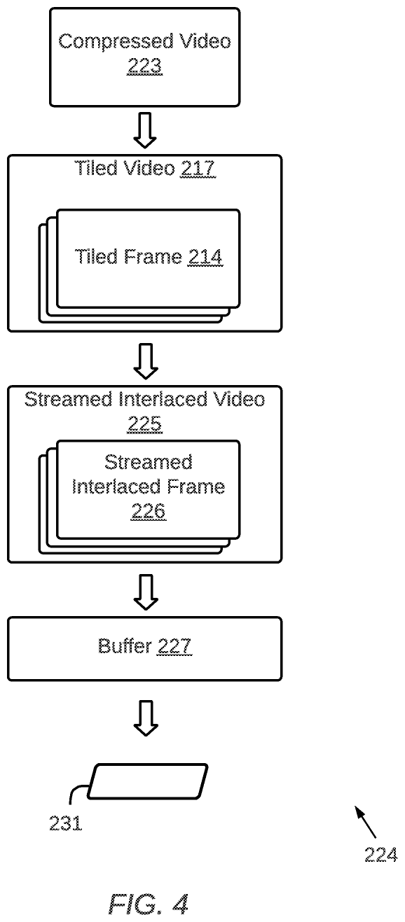

FIG. 4 illustrates an example of receiving streamed multiview video from a sender client device according to an embodiment consistent with the principles described herein. FIG. 4 depicts a receiver client device 224 that receives a stream of compressed video 223. As discussed above, the compressed video 223 may include tiled video comprising tiled frames, where each tiled frame includes deinterlaced, concatenated views of a multiview image (e.g., multiview image 103 of FIG. 1). The receiver client device 224 may be configured to decompress the tiled video 217 received from the sender client device 203. For example, the receiver client device 224 may include a video decoder that decompresses a received stream of compressed video 223.

Once the tiled video 217 is decompressed, the receiver client device 224 may interlace the tiled frame 214 into spatially multiplexed views defined by a multiview configuration having a second number of views to generate a streamed interlaced video 225. The streamed interlaced video 225 may include streamed interlaced frames 226 that are rendered for display at the receiver client device 224. Specifically, the streamed interlaced video 225 may be buffered in a buffer 227 (e.g., a primary framebuffer of the receiver client device 224). The receiver client device 224 may include a multiview display 231 such as, for example, the multiview display 112 of FIG. 1 or FIG. 2. The multiview display 231 may be configured according to a multiview configuration that specifies a maximum number of views capable of being presented by the multiview display 231, a particular orientation of the views or both.

The multiview display 205 of the sender client device 203 may be defined by a multiview configuration having a first number of views while the multiview display 231 of the receiver client device 224 is defined by a multiview configuration having a second number of views. In some embodiments, the first number of views and second number of views may be the same. For example, the sender client device 203 may be configured to present four-view multiview video and stream that video to a receiver client device 224 that also presents it as four-view multiview video. In other embodiments, the first number of views may be different from the second number of views. For example, the sender client device 203 may stream video to a receiver client device 224 regardless of the multiview configuration of the multiview display 231 of the receiver client device 224. In this respect, the sender client device 203 does not need to account for the type of multiview configuration of the receiver client device 224.

In some embodiments, the receiver client device 224 is configured to generate an additional view for the tiled frame 214 when the second number of views is larger than the first number of views. The receiver client device 224 may synthesize new views from each tiled frame 214 to generate the number of views supported by the multiview configuration of the multiview display 231. For example, if each tiled frame 214 contains four views and the receiver client device 224 supports eight views, then the receiver client device 224 may perform view synthesis operations to generate additional views for each tiled frame 214. The streamed interlaced video 225 that is rendered at the receiver client device 224 is therefore similar to the interlaced video 208 rendered at the sender client device 203. However, it is possible that there may be some loss in quality due to the compression and decompression operations involved in video streaming. In addition, as explained above, the receiver client device 224 may add or remove view(s) to accommodate the differences in multiview configurations between the sender client device 203 and receiver client device 224.

View synthesis includes operations that interpolate or extrapolate one or more original views to generate a new view. View synthesis may involve one or more of forward warping, a depth test, and an in-painting technique to sample nearby regions such as to fill de-occluded regions. Forward warping is an image distortion process that applies a transformation to a source image. Pixels from the source image may be processed in a scanline order and the results are projected onto a target image. A depth test is a process where fragments of an image that are processed or to be processed by a shader have depth values that are tested with respect to a depth of a sample to which it is being written. Fragments are discarded when the test fails. And a depth buffer is updated with the output depth of the fragment when the test passes. In-painting refers to filling in missing or unknown regions of an image. Some techniques involve predicting pixel values based on nearby pixels or reflecting nearby pixels onto an unknown or missing region. Missing or unknown regions of an image may result from scene de-occlusion, which refers to a scene object that is partially covered by another scene object. In this respect, re-projection may involve image processing techniques to construct a new perspective of a scene from an original perspective. Views may be synthesized using a trained neural network.

In some embodiments, the second number of views may be fewer than the first number of views. The receiver client device 224 may be configured to remove a view of the tiled frame 214 when the second number of views is less than the first number of views. For example, if each tiled frame 214 contains four views and the receiver client device 224 supports only two views, then the receiver client device 224 may remove two views from the tiled frame 214. This results in converting a four-view tiled frame 214 into two views.

The views of the tiled frame 214 (which may include any newly added views or newly removed views) are interlaced to generate the streamed interlaced video 225. The manner of interlacing may be dependent on the multiview configuration of the multiview display 231. The receiver client device 224 is configured to render the streamed interlaced video 225 on a multiview display 231 of the receiver client device 224. The resulting video is similar to the video rendered on the multiview display 205 of the sender client device 203. The streamed interlaced video 225 is decompressed and interlaced according to the multiview configuration of the receiver client device 224. Thus, the lightfield experience on the sender client device 203 may be replicated in real time by one or more receiver client devices 224 regardless of the multiview configurations of the receiver client devices 224. For example, transmitting the tiled video comprises streaming the tiled video in real time using an application programming interface.

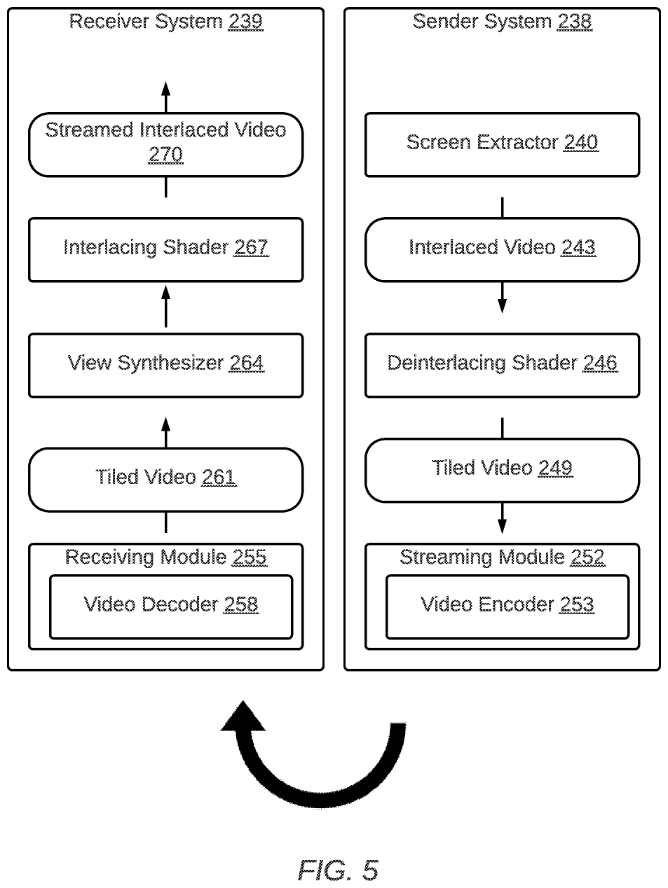

FIG. 5 illustrates an example of the functionality and architectures of sender and receiver systems, according to an embodiment consistent with the principles described herein. For example, FIG. 5 depicts a sender system 238 that streams video to one or more receiver systems 239. The sender system 238 may be embodied as a sender client device 203 that is configured to transmit compressed video for streaming lightfield content to one or more receiver systems 239. The receiver system 239 may be embodied as a receiver client device 224.

A sender system 238 may include, for example, a multiview display (e.g., the multiview display 205 of FIG. 3) configured according to a multiview configuration having a number of views. The sender system 238 may include a processor such as, for example, a CPU, a GPU, specialized processing circuitry, or any combination thereof. The sender system may include a memory that stores a plurality of instructions, when executed, cause the processor to perform various video streaming operations. The sender system 238 may be a client device or include some components of a client device, as discussed in further detail below with respect to FIG. 6.

With respect to the sender system 238, the video streaming operations include operations that render an interlaced frame of an interlaced video on the multiview display. The sender system 238 may include a graphics pipeline, multiview display drivers, and multiview display firmware to convert video data into light beams that visually display the interlaced video as multiview video. For example, interlaced frames of the interlaced video 243 may be stored in memory as pixel arrays that are mapped to physical pixels of the multiview display. The interlaced frames may be in an uncompressed format that is native to the sender system 238. A multiview backlight may be selected to emit directional light beams and a light valve array may then be controlled to modulate the directional light beams to produce multiview video content to the viewer.

The video streaming operations further include operations that capture the interlaced frame in the memory, the interlaced frame being formatted as spatially multiplexed views defined by the multiview configuration having a first number of views of the multiview display. The sender system 238 may include a screen extractor 240. The screen extractor may be a software module that accesses interlaced frames (e.g., interlaced frame 211 of FIG. 3) from graphics memory, where the interlaced frames represent the video content that is rendered (e.g., rendered or about to be rendered) on the multiview display. The interlaced frame may be formatted as texture data that is accessible using an API. Each interlaced frame may be formatted as views of a multiview image that are interlaced or otherwise spatially multiplexed. The number of views and the manner of interlacing and arranging multiview pixel may be controlled by the multiview configuration of the multiview display. The screen extractor 240 provides access to a stream of interlaced video 243, which is uncompressed video. Different player applications may render interlaced video 243 that is then captured by the screen extractor 240.

The video streaming operations further include operations that deinterlace the spatially multiplexed views of the interlaced video into separate views, the separate views being concatenated to generate a tiled frame of a tiled video 249. For example, the sender system 238 may include a deinterlacing shader 246. A shader may be a module or program executed in a graphics pipeline to process texture data or other video data. The deinterlacing shader 246 generates a tiled video 249 made up of tiled frames (e.g., tiled frames 214). Each tiled frame contains views of a multiview frame, where the videos are separated and concatenated so that they are arranged in separate regions of the tiled frame. Each tile in the tiled frame may represent a different view.

The video streaming operations further include operations that transmit the tiled video 249 to a receiver system 239, the tiled video 249 being compressed. For example, the sender system 238 may transmit the tiled video 249 by streaming the tiled video 249 in real time using an API. As the multiview content is rendered for display by the sender system 238, the sender system 238 provides a real-time stream of that content to the receiver system 239. The sender system 238 may include a streaming module 252 that transmits the outbound video stream to the receiver system 239. The streaming module 252 may use a third-party API to stream the compressed video. The streaming module 252 may include a video encoder 253 (e.g., a CODEC) that compresses the tiled video 249 prior to transmission of the tiled video 249.

The receiver system 239 may include, for example, a multiview display (e.g., the multiview display 231) configured according to a multiview configuration having a number of views. The receiver system 239 may include a processor such as, for example, a CPU, a GPU, specialized processing circuitry, or any combination thereof. The receiver system 239 may include a memory that stores a plurality of instructions, when executed, cause the processor to perform operations of receiving and rendering a video stream. The receiver system 239 may be a client device or include components of a client device, such as, for example, the client device discussed with respect to FIG. 6.

The receiver system 239 may be configured to decompress the tiled video 261 received from the sender system 238. The receiver system 239 may include a receiving module 255 that receives compressed video from the sender system 238. The receiving module 255 may buffer the received compressed video in memory (e.g., a buffer). The receiving module 255 may include a video decoder 258 (e.g., a CODEC) for decompressing the compressed video into tiled video 261. The tiled video 261 may be similar to the tiled video 249 processed by the sender system 238. However, it is possible that some quality is lost due to the compression and decompression of the video stream. This is the result of using a lossy compression algorithm.

The receiver system 239 may include a view synthesizer 264 to generate a target number of views for each tiled frame in the tiled video 261. New views may be synthesized for each tiled frame or views may be removed from each tiled frame. The view synthesizer 264 converts the number views present in each tiled frame to a achieve a target number of views specified by the multiview configuration of the multiview display of the receiver system 239. The receiver system 239 may be configured to interlace the tiled frame into spatially multiplexed views defined by a multiview configuration having a second number of views and to generate a streamed interlaced video 270. For example, the receiver system 239 may include an interlacing shader 267 that receives separate views of the frame (e.g., with any newly synthesized views or with some views removed) and interlaces the views according to the multiview configuration of the receiver system 239 to generate streamed interlaced video 270. The streamed interlaced video 270 may be formatted to conform to the multiview display of the receiver system 239. Thereafter, the receiver system 239 may render the streamed interlaced video 270 on a multiview display of the receiver system 239. This provides real-time streaming of lightfield content from the sender system 238 to the receiver system 239.

Thus, according to embodiments, the receiver system 239 may perform various operations including receiving streamed multiview video from a sender system 238 by a receiver system 239. For example, the receiver system 239 may perform operations such as, receiving tiled video from a sender system 238. The tiled video may comprise a tiled frame, where the tiled frame comprises separate views that are concatenated. A number of the views of the tiled frame may be defined by a multiview configuration having a first number of views of the sender system 238. In other words, the sender system 238 may generate the tiled video stream according to the number of views supported by the sender system 238. The receiver system 239 may perform additional operations such as, for example, decompressing the tiled video and interlacing the tiled frame into spatially multiplexed views defined by a multiview configuration having a second number of views to a generate a streamed interlaced video 270.

As mentioned above, the multiview configurations between the sender system 238 and receiver system 239 may be different such that the each support a different number of views or a different orientation of those views. The receiver system 239 may perform operations of generating an additional view for the tiled frame when the second number of views is larger than the first number of views or removing a view of the tiled frame when the second number of views is fewer than the first number of views. Thus, the receiver system 239 may synthesize additional views or remove views from the tiled frames to arrive at a target number of views supported by the receiver system 239. The receiver system 239 may then perform operations of rendering the streamed interlaced video 270 on a multiview display of the receiver system 239.

FIG. 5 depicts various components or modules within the sender system 238 and receiver system 239. If embodied in software, each box (e.g., the screen extractor 240, the deinterlacing shader 246, the streaming module 252, the receiving module 255, the view synthesizer, 264, or the interlacing shader 267) may represent a module, segment, or portion of code that comprises instructions to implement the specified logical function(s). The instructions may be embodied in the form of source code that comprises human-readable statements written in a programming language, object code that is compiled from source code, or machine code that comprises numerical instructions recognizable by a suitable execution system, such as a processor a computing device. The machine code may be converted from the source code, etc. If embodied in hardware, each block may represent a circuit or a number of interconnected circuits to implement the specified logical function(s).

Although FIG. 5 shows a specific order of execution, it is understood that the order of execution may differ from that which is depicted. For example, the order of execution of two or more boxes may be scrambled relative to the order shown. Also, two or more boxes shown may be executed concurrently or with partial concurrence. Further, in some embodiments, one or more of the boxes may be skipped or omitted.

FIG. 6 is a schematic block diagram that depicts an example illustration of a client device according to an embodiment consistent with the principles described herein. The client device 1000 may represent a sender client device 203 or a receiver client device 224. In addition, the components of the client device 1000 may be described as a sender system 238 or receiver system 239. The client device 1000 may include a system of components that carry out various computing operations for streaming multiview video content from a sender to a receiver. The client device 1000 may be a laptop, tablet, smart phone, touch screen system, intelligent display system, or other client device. The client device 1000 may include various components such as, for example, a processor(s) 1003, a memory 1006, input/output (I/O) component(s) 1009, a display 1012, and potentially other components. These components may couple to a bus 1015 that serves as a local interface to allow the components of the client device 1000 to communicate with each other. While the components of the client device 1000 are shown to be contained within the client device 1000, it should be appreciated that at least some of the components may couple to the client device 1000 through an external connection. For example, components may externally plug into or otherwise connect with the client device 1000 via external ports, sockets, plugs, wireless links, or connectors.

A processor 1003 may be a central processing unit (CPU), graphics processing unit (GPU), any other integrated circuit that performs computing processing operations, or any combination thereof. The processor(s) 1003 may include one or more processing cores. The processor(s) 1003 comprises circuitry that executes instructions. Instructions include, for example, computer code, programs, logic, or other machine-readable instructions that are received and executed by the processor(s) 1003 to carry out computing functionality that are embodied in the instructions. The processor(s) 1003 may execute instructions to operate on data. For example, the processor(s) 1003 may receive input data (e.g., an image or frame), process the input data according to an instruction set, and generate output data (e.g., a processed image or frame). As another example, the processor(s) 1003 may receive instructions and generate new instructions for subsequent execution. The processor 1003 may comprise the hardware to implement a graphics pipeline for processing and rendering video content. For example, the processor(s) 1003 may comprise one or more GPU cores, vector processors, scaler processes, or hardware accelerators.

The memory 1006 may include one or more memory components. The memory 1006 is defined herein as including either or both of volatile and nonvolatile memory. Volatile memory components are those that do not retain information upon loss of power. Volatile memory may include, for example, random access memory (RAM), static random access memory (SRAM), dynamic random access memory (DRAM), magnetic random access memory (MRAM), or other volatile memory structures. System memory (e.g., main memory, cache, etc.) may be implemented using volatile memory. System memory refers to fast memory that may temporarily store data or instructions for quick read and write access to assist the processor(s) 1003.

Nonvolatile memory components are those that retain information upon a loss of power. Nonvolatile memory includes read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive. The ROM may comprise, for example, a programmable read-only memory (PROM), an erasable programmable read-only memory (EPROM), an electrically erasable programmable read-only memory (EEPROM), or other like memory device. Storage memory may be implemented using nonvolatile memory to provide long term retention of data and instructions.

The memory 1006 may refer to the combination of volatile and nonvolatile memory used to store instructions as well as data. For example, data and instructions may be stored in nonvolatile memory and loaded into volatile memory for processing by the processor(s) 1003. The execution of instructions may include, for example, a compiled program that is translated into machine code in a format that can be loaded from nonvolatile memory into volatile memory and then run by the processor 1003, source code that is converted in suitable format such as object code that is capable of being loaded into volatile memory for execution by the processor 1003, or source code that is interpreted by another executable program to generate instructions in volatile memory and executed by the processor 1003, etc. Instructions may be stored or loaded in any portion or component of the memory 1006 including, for example, RAM, ROM, system memory, storage, or any combination thereof.

While the memory 1006 is shown as being separate from other components of the client device 1000, it should be appreciated that the memory 1006 may be embedded or otherwise integrated, at least partially, into one or more components. For example, the processor(s) 1003 may include onboard memory registers or cache to perform processing operations. Device firmware or drivers may include instructions stored in dedicated memory devices.

I/O component(s) 1009 include, for example, touch screens, speakers, microphones, buttons, switches, dials, camera, sensors, accelerometers, or other components that receive user input or generate output directed to the user. I/O component(s) 1009 may receive user input and convert it into data for storage in the memory 1006 or for processing by the processor(s) 1003. I/O component(s) 1009 may receive data outputted by the memory 1006 or processor(s) 1003 and convert them into a format that is perceived by the user (e.g., sound, tactile responses, visual information, etc.).

A specific type of I/O component 1009 is a display 1012. The display 1012 may include a multiview display (e.g., multiview display 112, 205, 231), a multiview display combined with a 2D display, or any other display that presents images. A capacitive touch screen layer serving as an I/O component 1009 may be layered within the display to allow a user to provide input while contemporaneously perceiving visual output. The processor(s) 1003 may generate data that is formatted as an image for presentation on the display 1012. The processor(s) 1003 may execute instructions to render the image on the display for being perceived by the user.

The bus 1015 facilitates communication of instructions and data between the processor(s) 1003, the memory 1006, the I/O component(s) 1009, the display 1012, and any other components of the client device 1000. The bus 1015 may include address translators, address decoders, fabric, conductive traces, conductive wires, ports, plugs, sockets, and other connectors to allow for the communication of data and instructions.

The instructions within the memory 1006 may be embodied in various forms in a manner that implements at least a portion of the software stack. For example, the instructions may be embodied as part of an operating system 1031, an application(s) 1034, a device driver (e.g., a display driver 1037), firmware (e.g., display firmware 1040), other software components, or any combination thereof. The operating system 1031 is a software platform that supports the basic functions of the client device 1000, such as scheduling tasks, controlling I/O components 1009, providing access to hardware resources, managing power, and supporting applications 1034.

An application(s) 1034 executes on the operating system 1031 and may gain access to hardware resources of the client device 1000 via the operating system 1031. In this respect, the execution of the application(s) 1034 is controlled, at least in part, by the operating system 1031. The application(s) 1034 may be a user-level software program that provides high-level functions, services, and other functionality to the user. In some embodiments, an application 1034 may be a dedicated ‘app’ downloadable or otherwise accessible to the user on the client device 1000. The user may launch the application(s) 1034 via a user interface provided by the operating system 1031. The application(s) 1034 may be developed by developers and defined in various source code formats. The applications 1034 may be developed using a number of programming or scripting languages such as, for example, C, C++, C #, Objective C, Java®, Swift, JavaScript®, Perl, PUP, Visual Basic®, Python®, Ruby, Go, or other programming languages. The application(s) 1034 may be compiled by a compiler into object code or interpreted by an interpreter for execution by the processor(s) 1003. The application 1034 may be the application that allows a user to select and choose receiver client devices for streaming multiview video content. The player application 204 and streaming application 213 are examples of applications 1034 that execute on the operating system.

Device drivers such as, for example, the display driver 1037, include instructions that allow the operating system 1031 to communicate with various I/O components 1009. Each I/O component 1009 may have its own device driver. Device drivers may be installed such that they are stored in storage and loaded into system memory. For example, upon installation, a display driver 1037 translates a high-level display instruction received from the operating system 1031 into lower level instructions implemented by the display 1012 to display an image.

Firmware, such as, for example, display firmware 1040, may include machine code or assembly code that allows an I/O component 1009 or display 1012 to perform low-level operations. Firmware may convert electrical signals of particular component into higher level instructions or data. For example, display firmware 1040 may control how a display 1012 activates individual pixels at a low level by adjusting voltage or current signals. Firmware may be stored in nonvolatile memory and executed directly from nonvolatile memory. For example, the display firmware 1040 may be embodied in a ROM chip coupled to the display 1012 such that the ROM chip is separate from other storage and system memory of the client device 1000. The display 1012 may include processing circuitry for executing the display firmware 1040.

The operating system 1031, application(s) 1034, drivers (e.g., display driver 1037), firmware (e.g., display firmware 1040), and potentially other instruction sets may each comprise instructions that are executable by the processor(s) 1003 or other processing circuitry of the client device 1000 to carry out the functionality and operations discussed above. Although the instructions described herein may be embodied in software or code executed by the processor(s) 1003 as discussed above, as an alternative, the instructions may also be embodied in dedicated hardware or a combination of software and dedicated hardware. For example, the functionality and operations carried out by the instructions discussed above may be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc.

In some embodiments, the instructions that carry out the functionality and operations discussed above may be embodied in a non-transitory, computer-readable storage medium. The non-transitory, computer-readable storage medium may or may not be part of the client device 1000. The instructions may include, for example, statements, code, or declarations that can be fetched from the computer-readable medium and executed by processing circuitry (e.g., the processor(s) 1003). Has defined herein, a ‘non-transitory, computer-readable storage medium’ is defined as any medium that can contain, store, or maintain the instructions described herein for use by or in connection with an instruction execution system, such as, for example, the client device 1000, and further excludes transitory medium including, for example, carrier waves.

The non-transitory, computer-readable medium can comprise any one of many physical media such as, for example, magnetic, optical, or semiconductor media. More specific examples of a suitable non-transitory, computer-readable medium may include, but are not limited to, magnetic tapes, magnetic floppy diskettes, magnetic hard drives, memory cards, solid-state drives, USB flash drives, or optical discs. Also, the non-transitory, computer-readable medium may be a random access memory (RAM) including, for example, static random access memory (SRAM) and dynamic random access memory (DRAM), or magnetic random access memory (MRAM). In addition, the non-transitory, computer-readable medium may be a read-only memory (ROM), a programmable read-only memory (PROM), an erasable programmable read-only memory (EPROM), an electrically erasable programmable read-only memory (EEPROM), or other type of memory device.

The client device 1000 may perform any of the operations or implement the functionality described above. For example, the process flows discussed above may be performed by the client device 1000 that executes instructions and processes data. While the client device 1000 is shown as a single device, embodiments are not so limited. In some embodiments, the client device 1000 may offload processing of instructions in a distributed manner such that a plurality of client devices 1000 or other computing devices operate together to execute instructions that may be stored or loaded in a distributed arranged. For example, at least some instructions or data may be stored, loaded, or executed in a cloud-based system that operates in conjunction with the client device 1000.

Thus, there have been described examples and embodiments of accessing interlaced (e.g., uncompressed) multiview video frames that are rendered on a sender system, deinterlacing these frames into separate views, concatenating the separated views to generate a tiled (e.g., deinterlaced) frame among a set of tiled frames, and compressing the tiled frames. A receiver system may decompress the tiled frames to extract separated views from each tiled frame. The receiver system may synthesize new views or remove views to achieve a target number of views supported by the receiver system. The receiver system may then interlace the views of each frame and render it for display. It should be understood that the above-described examples are merely illustrative of some of the many specific examples that represent the principles described herein. Clearly, those skilled in the art can readily devise numerous other arrangements without departing from the scope as defined by the following claims.

What is claimed is:

1. A method of streaming multiview video by a sender client device, the method comprising:
capturing an interlaced frame of an interlaced video rendered on a multiview display of the sender client device, the interlaced frame being formatted as spatially multiplexed views defined by a multiview configuration having a first number of views;
deinterlacing the spatially multiplexed views of the interlaced frame into separate views, the separate views being concatenated to generate a tiled frame of a tiled video; and
transmitting the tiled video to a receiver client device, the tiled video being compressed.

2. The method of streaming multiview video by the sender client device of claim 1, wherein capturing the interlaced frame of the interlaced video comprises accessing texture data from graphics memory using an application programming interface.

3. The method of streaming multiview video by the sender client device of claim 1, wherein transmitting the tiled video comprises streaming the tiled video in real time using an application programming interface.

4. The method of streaming multiview video by the sender client device of claim 1 further comprises compressing the tiled video prior to transmitting the tiled video.

5. The method of streaming multiview video by the sender client device of claim 1, wherein the receiver client device is configured to:
decompress the tiled video received from the sender client device;
interlace the tiled frame into spatially multiplexed views defined by a multiview configuration having a second number of views to generate a streamed interlaced video; and
render the streamed interlaced video on a multiview display of the receiver client device.

6. The method of streaming multiview video by the sender client device of claim 5, wherein the first number of views is different from the second number of views.

7. The method of streaming multiview video by the sender client device of claim 6, wherein the receiver client device is configured to generate an additional view for the tiled frame when the second number of views is larger than the first number of views.

8. The method of streaming multiview video by the sender client device of claim 6, wherein the receiver client device is configured to remove a view of the tiled frame when the second number of views is less than the first number of views.

9. The method of streaming multiview video by the sender client device of claim 1, wherein the multiview display of the sender client device is configured to provide a broad-angle emitted light during a 2D mode using a broad-angle backlight; and
wherein the multiview display of the sender client device is configured to provide a directional emitted light during a multiview mode using a multiview backlight having an array of multibeam elements, the directional emitted light comprising a plurality of directional light beams provided by each multibeam element of the multibeam element array; and
wherein the multiview display of the sender client device is configured to time multiplex the 2D mode and the multiview mode using a mode controller to sequentially activate the broad-angle backlight during a first sequential time interval corresponding to the 2D mode and the multiview backlight during a second sequential time interval corresponding to the multiview mode; and
wherein directions of the directional light beams correspond to different view directions of the interlaced frame of the multiview video.

10. The method of streaming multiview video by the sender client device of claim 1, wherein the multiview display of the sender client device is configured to guide light in a light guide as guided light; and
wherein the multiview display of the sender client device is configured to scatter out a portion of the guided light as directional emitted light using multibeam elements of a multibeam element array, each multibeam element of the multibeam element array comprising one or more of a diffraction grating, a micro-refractive element, and a micro-reflective element.

11. A sender system comprising:
a multiview display configured according to a multiview configuration having a number of views;
a processor; and
a memory that stores a plurality of instructions, when executed, cause the processor to:
render an interlaced frame of an interlaced video on the multiview display;
capture the interlaced frame in the memory, the interlaced frame being formatted as spatially multiplexed views defined by the multiview configuration having a first number of views of the multiview display;
deinterlace the spatially multiplexed views of the interlaced video into separate views, the separate views being concatenated to generate a tiled frame of a tiled video; and
transmit the tiled video to a receiver system, the tiled video being compressed.

12. The sender system of claim 11, wherein the plurality of instructions, when executed, further cause the processor to:
capture the interlaced frame of the interlaced video by accessing texture data from a graphics memory using an application programming interface.

13. The sender system of claim 11, wherein the plurality of instructions, when executed, further cause the processor to:
transmit the tiled video by streaming the tiled video in real time using an application programming interface.

14. The sender system of claim 11, wherein the plurality of instructions, when executed, further cause the processor to:
compress the tiled video prior to transmission of the tiled video.

15. The sender system of claim 11, wherein the receiver system is configured to:
decompress the tiled video received from the sender system;
interlace the tiled frame into spatially multiplexed views defined by a multiview configuration having a second number of views to generate a streamed interlaced video; and
render the streamed interlaced video on a multiview display of the receiver system.

16. The sender system of claim 15, wherein the first number of views is different from the second number of views.

17. The sender system of claim 16, wherein the receiver system is configured to generate an additional view for the tiled frame when the second number of views is larger than the first number of views.

18. A method of receiving streamed multiview video from a sender system by a receiver system, the method comprising:
receiving tiled video from a sender system, the tiled video comprising a tiled frame, the tiled frame comprising separate views that are concatenated, wherein a number of views of the tiled frame is defined by a multiview configuration having a first number of views of the sender system;
decompressing the tiled video;
interlacing the tiled frame into spatially multiplexed views defined by a multiview configuration having a second number of views to generate a streamed interlaced video; and
rendering the streamed interlaced video on a multiview display of the receiver system.

19. The method of receiving tiled video from the sender system of claim 18, further comprising:
generating an additional view for the tiled frame when the second number of views is larger than the first number of views.

20. The method of receiving tiled video from the sender system of claim 18, further comprising:
removing a view of the tiled frame when the second number of views is fewer than the first number of views.
